(19) United States
(12) Patent Application Publication
(10) Pub. No.: US 2017/0116814 A1
(43) Pub. Date: Apr. 27, 2017

(54) Drone Taxi Operation, Facilities & Management

(71) Applicants: Leonard Storch, New York, NY (US); Leonard Scott Storch, New York, NY (US); Nathan Johnson, New York, NY (US)

(72) Inventors: Leonard Storch, New York, NY (US); Leonard Scott Storch, New York, NY (US); Nathan Johnson, New York, NY (US)

(73) Assignee: CIAS Inc., New York, NY (US)

(21) Appl. No.: 15/294,804

(22) Filed: Oct. 17, 2016

Related U.S. Application Data
(60) Provisional application No. 62/244,310, filed on Oct. 21, 2015.

(51) Int. Cl. G07F 17/00; G06Q 50/30; G06Q 30/06; B64C 39/02; G07B 15/00

(52) U.S. Cl. CPC G07F 17/0057; B64C 39/024; G07B 15/00; G06Q 30/0609; G06Q 50/30; B64C 2201/12

(57) ABSTRACT

A transportation drone taxi facility, a taxi drone system operation, with advanced operational and safety features is disclosed.

### CROSS-REFERENCES TO RELATED U.S. APPLICATIONS

This application is a Utility Patent Application and it claims priority to Provisional Patent Application No. 62/244,310, Confirmation Number 6104, which was filed Oct. 21, 2015; said Provisional is incorporated by reference herein in its entirety.

### FIELD OF USE

The fields-of-use comprise drone taxi transportation conveyances that operate on, from and above sidewalks. A taxi (taxis plural; also known as a taxicab, cab and the like). Disclosed are facilities, management and implementation systems incorporating advanced operational and safety features, methods and structures therefor and thereof.

Subways have subway stations, buses have bus stops, taxis have taxi stands, trucks have truck plazas and wheelchairs have handicap zones. Drone taxis in urban environments (comprising cities, towns and villages & the like) will have, according to one embodiment of the present invention, drone taxi pick-up and delivery locations, referred to as a drone taxi location, or a drone zone, or “D”, for example, on signage.

A Google search of “drone transportation and its future” produced a link to an article titled “Forget Taxis—Get Ready To Hail A Drone” by Matthew DeBord, Sep. 30, 2014, 2:04 PM. There had been so much talk about drones and self-driving cars that I thought I'd take a look to see what it is all about. This article, which is prior art, seems to represent the state of the prior art. It appears Mr. DeBord's article was published on a website titled, “businessinsider.com”. To provide informational prior art background, and to incorporate Mr. DeBord's article's disclosure to provide disclosure to the fields-of-use disclosed and described herein, the text of Mr. DeBord's article follows verbatim:

“Drones plus flying cars equals . . . drone taxis?

“If you're comfortable with wagers, now could be the time to bet on the biggest transformation in how humans move around since we retired the horse from daily duty.

“Two major technological developments are converging: self-driving cars and semi-autonomous drones. Self-driving cars have enjoyed a more robust public rollout, thanks to Google and its appetite for investing in the future. In just a few short years, the search giant went from outfitting Toyota Priuses with bolted-on self-driving sensors to creating a stand-alone driverless design a Google Car—that eliminates the steering wheel and the brake and accelerator pedals.

“Drones have operated behind the scenes. Most people hear “drone” and think of the unmanned aerial vehicles (UAVs) that the military uses—instruments of battlefield surveillance that were modified to become weapons platforms. Their lethal performance has done nothing but improve, leading some to speculate that they may put pilots out of work before the end of the century.

“Undated handout image courtesy of the U.S. Air Force shows a MQ-1 Predator unmanned aircraft. The United States has agreed in principle to deploy U.S. Predator drones on Turkish soil “to aid in the fight against Kurdish separatist rebels, Prime Minister Tayyip Erdogan said. The U.S. military flies unarmed surveillance Predators based in Iraq and shares images and vital intelligence with Turkey to aid Ankara as it battles Kurdish Kurdistan Workers' Party (PKK) rebels who have camps in northern Iraq. REUTERS/U.S. Air Force/Lt Col Leslie Pratt/Handout

“The drone has been weaponized—but can it be taxi-fied?

But with big names in tech like Amazon pushing the envelope on what one might term “utilitarian” drones—drones designed to deliver stuff—it's not hard to speculate on UAVs that will be more than modified gyrocopters that enthusiasts mount GoPro camera on and use to shoot videos of weddings and whales.

“Moore's Law for Drones

“The era of what I call the “heavy drone” could arrive sooner than anyone expects. And when drones can lift more than a hundred pounds, it won't be long before they'll lift 200, then 300, the 400. A sort of Moore's Law of drone-lifting capability should kick in, at which point venture capitalist Peter Thiel's notorious quote about progress—“We were promised flying cars, but we got 140 characters”—will be dramatically addressed.

“Not by flying cars. But by drone taxis.

“It's probably worth noting that the mobile technology for organizing drone taxis already exists. It's called Uber. It currently functions as a type of market for human-driven transportation opportunities. Need a ride? Use Uber to seamlessly summon an available driver who wants to convert time to money.

“uberVictor J. Blue/Bloomberg via Getty Images

“Uber is already building the tech infrastructure.

“When driverless cars become more prevalent, especially in cities, Uber drivers may find themselves considering a fate similar to fighter pilots. Ironically, however, Uber drivers will have helped develop the technological infrastructure that leads to their demise.

“Driverless cars will accustom people to giving up control of the driving experience. Driverless taxis will be the next obvious evolution—fleets of driverless cars that provide on-demand mobility to people who don't own vehicles. As cars that lack drivers become as common and nonthreatening sight—remember that automobiles were once a frightening novelty that scared horses—drones will also assume a less unusual status.

““What's that up in the sky?”

““It's just a snowblower and a flat screen TV for the next door neighbor.”

“The Great Drone Convergence

“Earlier this yes, Amazon CEO Jeff Bezos told a group of schoolchildren than drone taxis could be on the horizon. And at the higher end, the private jet industry has been exploring ways to reduce the number of pilots required to fly planes and considering the prospect that some jets could go completely pilotless for cargo-only flights.

“There are countless legal, regulatory, and perhaps even aesthetic hurdles for us to contend with before we witness a great convergence of self-driving cars, autonomous drones, and the technology required to facilitate their collaboration. But artists and futurists are already looking forward to urban skyscapes that are filled with drones. The Atlantic's CityLab reported earlier this year on a project created by futurist Liam Young that enables viewers to experience subjectively the life of a flying drone.

“Drone ArtScreenshot via cityofdrones.io

“The life of a drone.

“And the advanced mobility community—experts who make a living forecasting how we'll get around in the coming decades—have already outlined a late 21st century in which personal cars meet the same fast as personal horses in the early 20th.

“Science fiction has a way of morphing into tangible progress. Thiel is being confrontationally witty in his comment about asking for flying cars but getting Twitter. However, there is an actual flying car, produced by the U.S. company Terrafugia, that's coming soon to a skyway near you (okay, it's more of a “driving plane,” but still . . . ). A driver-cars become self-driving cars, so could flying cars become self-flying cars.

“Terrafugia TransitionScreenshot via Terrafugia

“The flying car is currently . . . flying.

“The critical factor is safety. But Google has so far been able to avoid any major accidents with its self-driving prototype cars. There could be mishaps as these vehicles are released into the wild, so to speak—but cars controlled by drivers result in over 30,000 annual fatalities each year in the U.S. And we still sell over 16 million of them each year. There are 250 million of them on the country's roads.

“If driverless cars kill only half as many people—it's more likely that auto-related deaths would plunge—it would be a very significant development. If a delivery drone can left 500 pounds and fly them from a warehouse to customer's address, without crashing into anything or causing collateral damage, then numerous entrepreneurs are going to think about offering that same delivery service to human passengers.

“If you follow the logic, the drone taxi doesn't really seem like a dream. Rather, it sounds inevitable.”

Mr. DeBord's article ends here.

A single insightful “Insiders” comment followed Mr. DeBord's article. The comment came from Insider “jp32” on Sep. 30, 2014, 3:07 PM; “jp32,” obviously a PHOSITA in the know, said:

“Inevitable, for sure. The technology is not far away for any part of such a system. Powerful, lightweight motors, strong lightweight airframes, automatic control systems for all kinds of rotor configurations, auto-sensing and auto-pilot systems for navigation, etc., distributed scheduling and app systems, are all here, and not far from what would be required.

“But, we need to wonder about the timescale. Transporting 500 Lbs safely, efficiently and economically is one challenge, but getting a human-rating for the the vehicle and control systems is a whole other level of development, expense, and regulation.

“Considering how the FAA is so totally dragging its feet and massively screwing up the drone business while it is still in its infancy, I'm not so optimistic.”

### Inventor's Statement-of-Invention

### His Dire Personal Safety Connection

Background: I (Lenny Storch, the inventor herein) have always been a self-employed career inventor, and I have been granted dozens of patents in many greatly diverse fields of art; my first patent issued in 1969. My works span from punctuation marks (the Question Comma & Exclamation Comma—the two missing halves parts of two pairs, to wit—./, and :/; and (/) but ?/ and !/ are missing their Comma-mates) to strap-on prosthetics with a rabbit for the “giver” improvement (“Rabbutt™”, filed on my birthday, Jan. 20, 2016, and allowed in record time—the NOA was mailed last month on Sep. 30, 2016, application Ser. No. 15/001,317, which has not yet been publicly posted on PAIR).

After my patent attorney since 1979 retired in 2014, I've been prosecuting my applications pro se. And, as one may already have noticed, I've taken inventor's liberties in my patent writings. I believe that every writing, no matter its primary purpose, should be interesting, edifying and/or entertaining as reasonably possible. Now, at 73 and ill, I have learned to stop & smell all roses wherever & whenever found before they wilt before meeting my maker after I wilt. Please feel free to skip to the headline “Safety” to continue the taxi drone disclosure if you've a mind to.

In regard to the explicit nature of my Rabbutt subject matter, initially I had reservations, so I consulted two doctors and two psychotherapists to get serious opinions. They thought I had invented something very special, saying in essence that my invention would afford myriad couples the world over uniquely satisfying sexual experiences for the rest of their active lives—inventing does not get better than that! What the Jack Rabbit® did for lone ladies, Rabbutt™ will do for myriad couples. One estimate is that over 750,000,000 Jack Rabbit-type bedroom prosthetics have been purchased by people in almost every nation. When it comes to strap-on prosthetics, Rabbutt is the best mouse trap since sliced bread.

My family means the world to me, and our son Scott, 27, is my and my wife's pride and joy. Scott is proud of his father the inventor and his mother the artist. Scott is in his third year-studies toward a Linguistics PhD degree. Last semester Scott wrote a paper about punctuation, and he asked me how to cite my patented punctuation marks. After Scott helped me proofread one of my Rabbutt patent applications, I asked him about his feelings given its explicit sexual nature. I asked: After I'm gone, would it bother you if your father were remembered for his Rabbutt invention? After a moment he answered, No, but it would be nice if you were also remembered for some of your other accomplishments, like your punctuation marks. I created the graphics in FIG. 4 in the 1990s; I tried to make a self-explanatory pleasing art form comprised of words.

Pearl S. Buck's sentiment appears to be a look into the delicate mind of a creative person with at least a “Bipolar-Lite Disorder.” Perhaps many are so blessed & so afflicted; such creativity is a two-edged sword, for example, it can lead one to indulge in harmful excesses; luckily, my Dad taught me, everything in moderation. It is reported that Ms. Buck said:
“The truly creative mind in any field is no more than this: A human creature born abnormally, inhumanly sensitive. To him a touch is a blow, a sound is a noise, a misfortune is a tragedy, a joy is an ecstasy, a friend is a lover, a lover is a god, and failure is death. Add to this cruelly delicate organism the overpowering necessity to create, create, create—so that without the creating of music or poetry or books or buildings or something of meaning, his very breath is cut off from him. He must create, must pour out creation. By some strange, unknown, inward urgency he's not really alive unless he is creating.” (Wikiquote)

### SAFETY

So, to get on with it, after read Mr. DeBord's article last year that, according to the state-of-the-art, “The critical factor is safety, ” and Insider “jp32's” further comment saying, “Considering how the FAA is so totally dragging its feet and massively screwing up the drone business while it is still in its infancy, I'm not so optimistic” it struck me that “safety,” the critical factor for drone taxis, was right up my alley, perhaps my unique Calling! For extreme personal reasons, I, as a career-inventor, had been focused on safety since 2012!

I was resigned to using a wheelchair in 2010. In 2012 I was using the handrails on my wheelchair to propel when I hit an irregularity on a sidewalk tilted for rain which helped tip my chair down a stone staircase bordering the sidewalk going to a townhouse basement on West 76^{th} Street, and that accident almost killed me. After I was hospitalized for a week for a concussion, intracranial hemorrhage and extensive physical and mental trauma, I received a $65,000 hospital bill (even the co-pay was staggering), and I required serious Occupational and Physical Therapy to recuperate after leaving the hospital.

Since that death-defying accident in 2012, I've gotten 4 US patents comprised of claims claiming mechanical means for safer operation of wheelchairs & baby strollers on sidewalks which are tilted for rain, and means to make pushing strollers easier and less stressful on the down-slope pushing arm. The fourth patent in that family is scheduled to issue tomorrow, Oct. 18, 2016, U.S. Pat. No. 9,469,325, application Ser. No. 14/734,131. In a 3-page Post Allowance Communication, on Jul. 7, 2016, I added to my patent-to-come's file history an 18-page thesis I created about sidewalks and safety thereon titled: “Unintended & Unforeseen Consequences of a Sidewalk Slanted 2° for Rain—A Study of Stroller & Wheelchair Pushing Efficiency” which is available now on PAIR for one's entertaining edification if one is so inclined a couple degrees or so. Personally, I believe that study represents one of my finest hours—it involved creating unique tools to analyze what has never before been noticed, no less analyzed. It took many months of intense effort to complete, and I had many false starts, and there was no help to be found, no model to follow to tackle the problem.

Yes, safety on sidewalks was my “dire” focus after reading Mr. DeBord's article, and I used some of my wheelchairs & baby strollers' drawings I had crafted for those patents to depict the drone zone on a typical sidewalk for the present drone taxi application (incidentally, I do all my own drawings with MS Paint; occasionally, my wife, an accomplished artist, will lend a drawing I scan into Paint).

Here's another record for me: For the first time in my long inventing career, last year on Jul. 14, 2015, two patents were issued to me, one for wheelchairs and one for strollers, both claiming sidewalk safety features. You might affectionately say, “Safety” is my middle name and I'd be flattered; I humbly think that I've earned that recognition of which I am quite proud.

Although I was keenly focused on drone-safety ideas that night after reading Dr. DeBord's article saying, “The critical factor is safety,” I was finally able to fall asleep. At about 4 am while sound asleep a eureka “flash” struck me in a dream—I sat up startled and yelled loudly enough to wake my wife. As I blinked I could see in my mind's eye a software flow chart with two authorized “safety flight plans,” each to satisfactorily address safety concerns. Thus, with safety, the “critical factor,” safely addressed, the required authorities could handily approve drone taxi operations! I mean that the “technology is not far away for any part of such a system” but the safety concern is the odd man out; meaning that a safe operating solution is not a given!, as Insider jp32's “not-so-optimistic” comment, about achieving required FAA's approval, teaches. I daresay, inventing doesn't get more personal than all that.

### OBJECTS AND SUMMARY

One of the objects of the present inventions is to disclose a transportation drone taxi operational facility & system comprising at least one computer associated therewith and at least two drone taxis each with an accommodation for a customer and each equipped with safety procedures, propulsion and guidance apparatus to carry and deliver a customer according to a customer-request to go from a first location to another location, said facility and drone taxis with improved operational and safety features being comprised of:

associated with said facility a transportation management program operating in a said computer to process and fulfill a customer-request for one drone taxi to carry a said customer from a first location to another location, a customer-request received by the computer for the customer;

information from the customer-request processed into a computer-request which is sent from the computer to at least one regulatory authority requesting authorized instructions to satisfy the customer-request;

instructions sent from the regulatory authority to satisfy the computer-request and received by the computer;

information sent by the computer to the customer according to the instructions sent from the regulatory authority, and the customer proceeds to the pick-up zone according to the instructions;

a response sent from the computer to the regulatory authority acknowledging that the instructions were received and are being followed;

instructions sent from the computer to one drone taxi's guidance apparatus to send the drone taxi to the pick-up zone according to instructions;

the drone taxi arrives at the pick-up zone and said customer enters and secures herself (or himself) in the drone taxi;

the computer confirms from the drone taxi computer that the drone taxi, with the customer in it, is in compliance with instructions and safety procedures;

the computer then sends to at least one authority drone taxi departure information according to the instructions and waits for an authorized confirmation; and,

confirmation from the at least one authority is received by the computer and the computer instructs the drone taxi to depart to the delivery zone whereupon arriving, the drone taxi computer informs the computer of its safe arrival at said another location and the customer debarks having safely gone from a first location to another location.

The transportation drone taxi facility may confirm with the customer that the instructions are agreeable; and bio recognition may be used to identify a passenger for a drone taxi; and payment, as may be required, if it has not already been arranged, may be made at the delivery location; and the drone taxi's power level may be checked and recharged if required when it arrives at a drone zone; and, a drone taxi may have a kill switch for an emergency.

### BRIEF DESCRIPTION OF THE DRAWINGS

FIG. 1 depicts a drone taxi 1 with an enclosure adapted to carry one or more passengers.

FIG. 2 depicts a futuristic city street 21 comprising a pick-up and/or delivery drone zone 13.

FIG. 3 is a drone taxi system 35, subsuming the flow of information, comprising parts of and depicting an embodiment of the present invention.

FIG. 4 shows two graphics, a question comma and an exclamation comma, created in the 1990s of a self-explanatory pleasing art form comprised of words.

### DETAILED DESCRIPTION

A transportation drone taxi facility, a taxi drone operation, with advanced operational and safety features, is disclosed as follows:

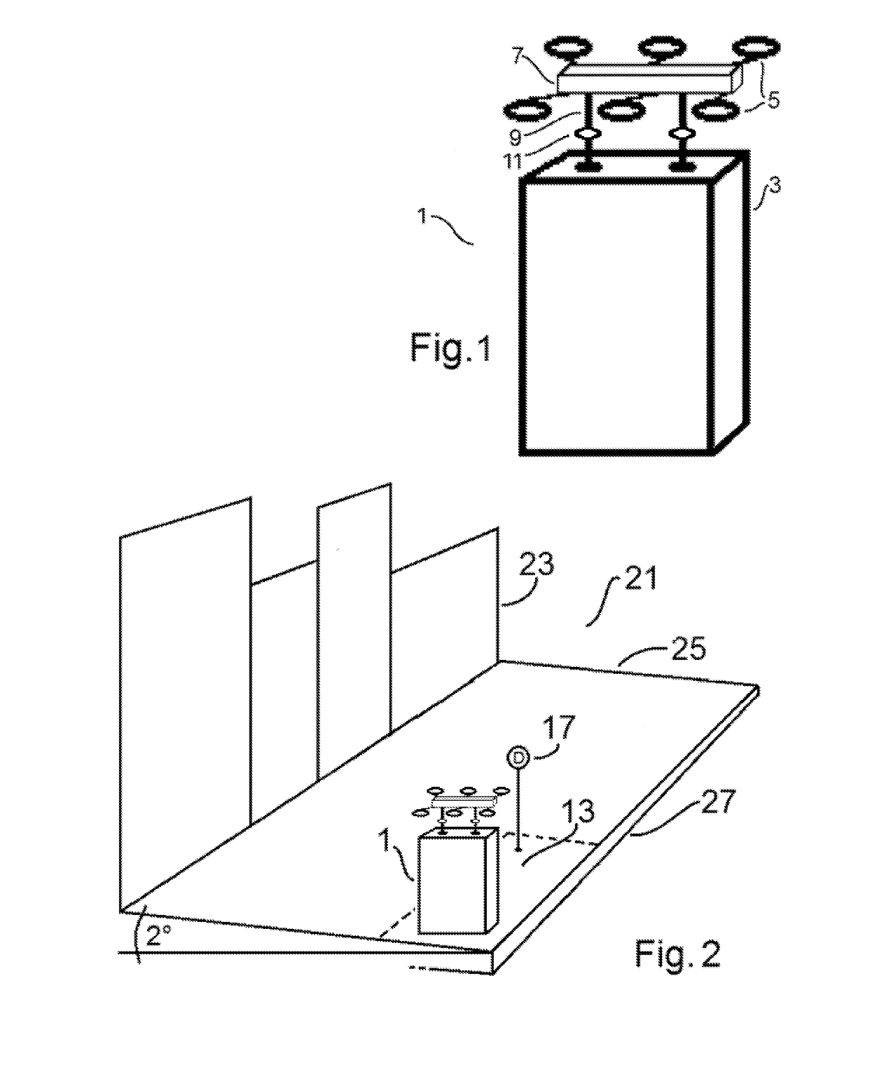

FIG. 1 depicts a drone taxi 1 which may comprise (some of which are depicted in FIG. 1) wings, an entrance(s), a window(s), an open or closed accommodation comprising seating for one or more people, various electrical outlet connections comprising AC voltage and USB, adaptations to carry an occupied wheelchair with or without an aide, a baby stroller and parent or other guardian, anti-terror devices comprised of danger detection apparatus, a refrigerated or non-refrigerated vending device, etc.

A drone taxi may be equipped with a kill switch in case an emergency situation occurs. In the event of an emergency, detected by the passenger and/or a computer, an emergency landing could be arranged by the passenger and/or a computer at the nearest available drone zone or elsewhere if warranted.

Referring to FIG. 1, a drone taxi is depicted with an accommodation; it is equipped with propulsion and guidance apparatus to carry and deliver at least one customer from a first location to another location. The guidance apparatus may utilize GPS, satellite, antenna, magnetic lines or other means to provide or aid guidance. A drone taxi's power assembly 7 is depicted which may be comprised of a battery, fuel-cell, various types of engines, an anti-gravity innovation or any energy source that exists or may be developed. Computer and guidance apparatus may be associated with the drone taxi's power assembly 7 or drone taxi. Propellers 5 may be linked to power assembly 7 (six propellers 5 are shown but any number could be used) and may be comprised of the conventional type or any other type to provide lift. Taxi accommodation 3 may be open to the air or closed and comprised of a conventional type or any other type accommodation.

Power assembly 7 is joined to accommodation 3 by two joiners 9 (two joiners 9 are shown but another number could be used); joiners 9 may link the power assembly 7 to taxi accommodation 3 in order to lift and transport it. Each joiner 9 has a hinge 11 which may tilt forward or backward (toward the long view of accommodation 3 as shown in FIG. 1) thereby when tilted providing propulsion in the direction tilted toward. One or both joiners 9 may extend up from or down into the top of accommodation 3 as shown to adjust the length of joiners 9 between power assembly 7 and accommodation 3. A disparity in length of joiners 9 will provide propulsion in one direction (toward the long view of accommodation 3 as shown in FIG. 1) or in the opposite direction. Or one joiner could be used with a gimbal (not shown) instead to direct propulsion. Computer and guidance apparatus, that may be associated with the drone taxi's power assembly 7 or elsewhere in drone taxi 1, could control hinges, adjustable length joiners 9 or the gimbal.

FIG. 2 depicts part of a futuristic city block 21 comprising: four buildings 23; sidewalk 25 (sidewalks are typically tilted 2 degrees for rain runoff; the sidewalk 25 could be comprised of any relatively flat pavement, plaza or promenade surface); curb 27; a drone taxi 1 parked in a drone zone 13 (zone 13 is delineated by dashed lines); and, drone D sign 17 (for example, so as to show where drone taxis is come to and go from). Drone taxis 1 may pick-up or deliver passengers from or to a drone zone 13.

Drone zone 13 may be adapted to allow the power level (if, for example, batteries are used for power) of a drone taxi 1 to automatically be checked and recharged or refilled as may be required. When a drone taxi 1 arrives at a drone zone 13, its power level may be checked and recharged or refilled as may be required via, for example, a recharge connection to a power source or by wireless means such as inductive recharging (which may, for example, be located in the ground out of sight under a drone zone 13).

A drone zone 13 or a portion thereof that the drone taxi sits on may be equipped to offset tilt associated with the drone zone location.

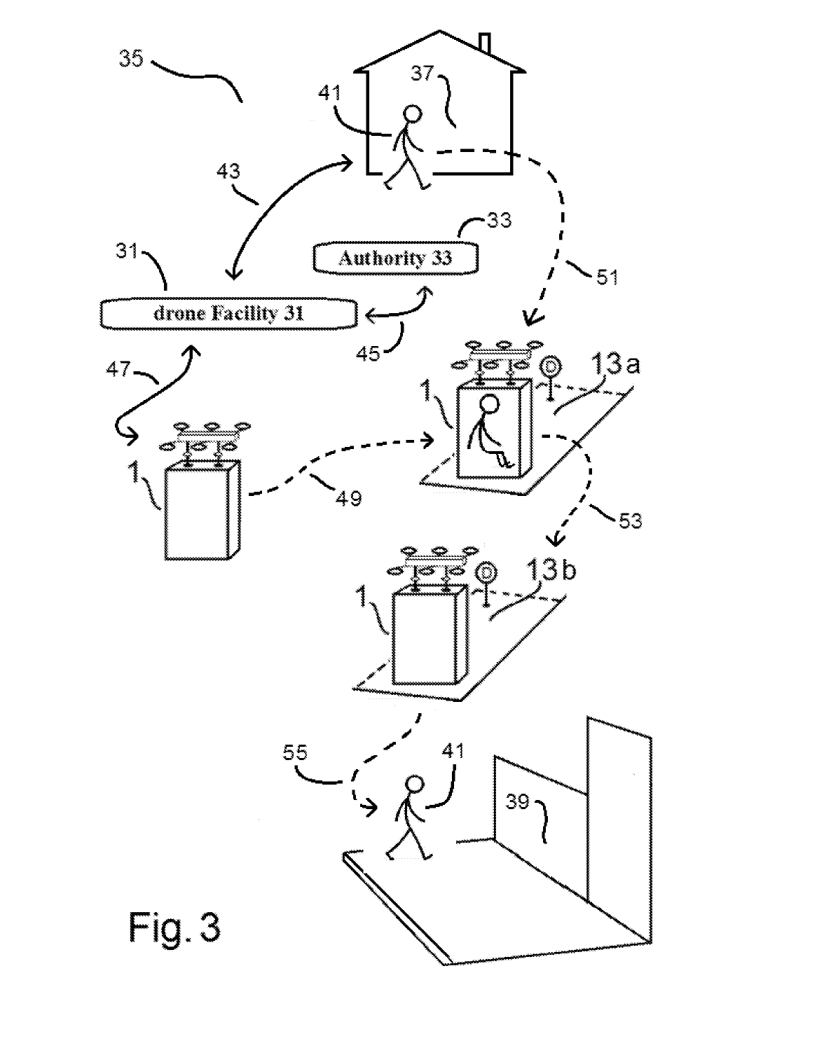

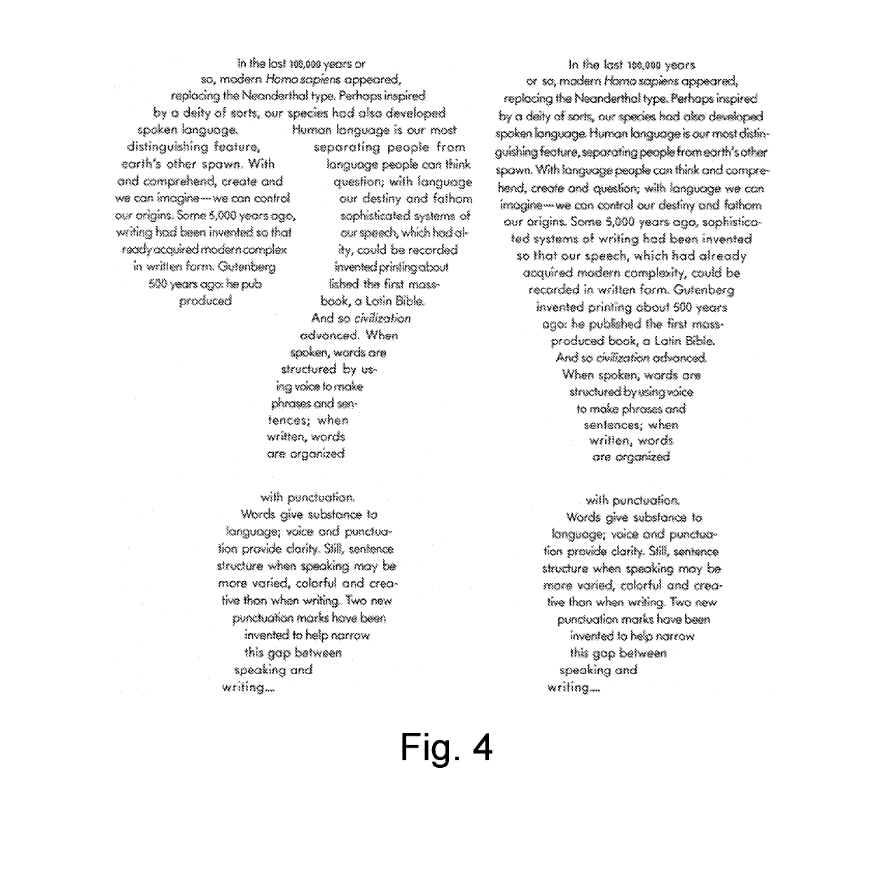

FIG. 3 depicting a door-to-door drone taxi system 35, subsuming an operational flow chart of information, depicts one embodiment of the present invention. The drone taxi system 35 comprises a transportation drone taxi operational Facility 31 and at least one computer associated with Facility 31 programmed with drone transportation management software operating therein, and at least two drone taxis each with an accommodation and each equipped with operational safety procedures, propulsion and guidance apparatus to carry and deliver a customer according to a customer-request from a first location to another location. The facility and drone taxis are equipped with improved operational and safety features.

FIG. 3's communication lines 43, 45 & 47 are solid lines and depict two-way communication while movement lines 49, 51, 53 & 55 are dashed lines and depict one-way (physical) movement. Bear in mind that communication between drone taxi 1 and drone Facility 31 may continue unabated along communication line 47 as the drone taxi 1 travels about town to pick up and deliver the customer (one communication line 47 is shown).

Preparation of computer program instructions to manage, for example, requests etc. associated with FIG. 3's operation as discussed, are well known in the art, and therefore are not detailed herein.

Referring to FIG. 3, drone taxi system 35 is now described by way of example using a customer named Jane 41 and her experience with a drone taxi 1 (as shown in FIGS. 1 and 2). Jane 41 lives at 175 West 72nd Street in Manhattan, home location 37. Jane 41 works at 8 West 40th Street in Manhattan, work location 39. Jane 41 wakes up one morning and wants to go to work quickly, or perhaps her employer wants her there quickly, or Jane simply prefers going about her work day in a drone taxi.

Jane 41 (or someone on her behalf) makes contact along communication line 43 with transportation drone Facility 31 via any kind of a device comprising phones, computers or any devices that operate over wires or fiber optics, or radio waves that operate through air or otherwise, or any other way of communication.

Jane 41 contacts drone Facility 31 and makes a request for a drone taxi 1, said request comprising Jane's location 37 for pick-up and her destination location 39. Drone Facility 31 contacts along communication line 45 at least one governmental regulatory authority, Authority 33, requesting instructions to fulfill Jane's request, and Authority 33 responds to said Facility 31's request and sends information comprising instructions to Facility 31. Facility 31 confirms with said authority that Facility 31 is in receipt of the instructions and, following said instructions, initiates sending a drone taxi 1 to a drone pick-up zone 13a which, according to the instructions, is convenient to location 37 to pick up Jane 41. Prior to 31 confirming said instructions with said authority that Facility 31 is in receipt of the instructions, Facility 31 may communicate with Jane 41 to ascertain if said instructions are okay with Jane 41 prior to confirming with said authority.

Regulatory authority may be associated with the Department of Transportation or its Federal Aviation Administration, or who knows what new authority may be established for drone taxis. There may be more than one authority or one authority may have more than one facility for regulating drone taxis. For example, one authority facility may be to respond to computer-requests and another authority facility may respond to the computer confirming that the drone taxi 1 has its customer secure and is ready to take off (described below).

Once the drone taxi 1, which is first shown hovering about—or it could be available and conveniently located in a drone zone or a drone depot or garage or the like—arrives along line 49 at pickup zone 13a Jane 41, having traveled along line 51, enters drone taxi 1 in pickup zone 13a and secures herself for her transport trip. Bio recognition apparatus may be associated with the drone taxi and used to identify Jane. If another passenger is detected instead of Jane a computer may be used to address and orchestrate a way to rectify the discrepancy.

Drone computer senses if customer is properly secured and if safety procedures and instructions are satisfied, and if compliance is confirmed, confirms compliance along line 47 with Facility 31 and/or to at least one authority directly (the communication line 47 is shown only once), and Jane's drone taxi 1 then travels according to the instructions along line 53 to drone zone 13b to deliver the customer to her destination, drone zone 13b. Drone computer confirms the safe arrival at zone 13b along line 47 with Facility 31 and/or to at least one authority directly. Jane debarks and travels along line 55 to location 39 and goes about her day.

Payment for said transport trip may be made in any manner, at any time, agreed between Jane and Facility 31; various payment means are well known in the relevant art. Bio recognition may be used to identify a passenger, for example, for payment. Upon arrival payment, as may be required, if it has not already been arranged, may then be made at the delivery location.

Certain changes and modifications of the embodiment(s) of the invention disclosed herein will be readily apparent to those skilled in the arts. Other terminology than used to disclose embodiment(s) of my invention herein may be used, as will be understood by PHOSITA. It is my intention to cover by the claim(s) any possible embodiment of my invention that does not depart from the spirit and scope of my invention.

I claim:

1. In a transportation drone taxi operational facility & system comprising at least one computer associated with said facility and at least two drone taxis each with an accommodation for a customer and each equipped with safety procedures, propulsion and guidance apparatus to carry and deliver a customer according to a customer-request to go from a first location to another location, said facility & system and drone taxis with improved operational and safety features being comprised of:
a) associated with said facility a transportation management program operating in a said computer to process and fulfill a customer-request for one drone taxi to carry a said customer from a first location to another location,
b) a customer-request received by the computer for the customer,
c) information from the customer-request processed into a computer-request which is sent from the computer to at least one regulatory authority requesting authorized instructions to satisfy the customer-request,
d) instructions sent from the regulatory authority to satisfy the computer-request and received by the computer,
e) information sent by the computer to the customer according to the instructions sent from the regulatory authority, and the customer proceeds to the pick-up zone according to the instructions,
f) a response sent from the computer to the regulatory authority acknowledging that the instructions were received and are being followed,
g) instructions sent from the computer to one drone taxi's guidance apparatus to send the drone taxi to the pick-up zone according to instructions,
h) the drone taxi arrives at the pick-up zone and said customer enters and secures herself (or himself) in the drone taxi,
i) the computer confirms from the drone taxi computer that the drone taxi, with the customer in it, is in compliance with instructions and safety procedures,
j) the computer then sends to at least one authority drone taxi departure information according to the instructions and waits for an authorized confirmation,
k) confirmation from the at least one authority is received by the computer and the computer instructs the drone taxi to depart to the delivery zone, and
l) whereupon arriving, the drone taxi computer informs the computer of its safe arrival at said another location and the customer debarks having safely gone from a first location to another location.

2. A transportation drone taxi facility according to claim 1 wherein Facility 31 may confirm with the customer that the instructions are agreeable.

3. A transportation drone taxi facility according to claim 1 wherein bio recognition is used to identify a passenger for a drone taxi.

4. A transportation drone taxi facility according to claim 1 wherein payment, as may be required, if it has not already been arranged, may then be made at the delivery location.

5. A transportation drone taxi facility according to claim 1 wherein a drone taxi's power level is checked and recharged if required when it arrives at a drone zone.

6. A transportation drone taxi facility according to claim 1 wherein a drone taxi has a kill switch for an emergency.
